(19) United States
(12) Patent Application Publication
(10) Pub. No.: US 2020/0002516 A1
(43) Pub. Date: Jan. 2, 2020

(54) ELASTOMERIC POLYMERS HAVING A THIOETHER-MODIFIED BACKBONE

(71) Applicant: TRINSEO EUROPE GMBH, Horgen (CH)

(72) Inventors: Christian DÖRING, Markranstadt (DE); Sven THIELE, Halle (DE)

(73) Assignee: TRINSEO EUROPE GMBH, Horgen (CH)

(21) Appl. No.: 16/095,199

(22) PCT Filed: May 3, 2017
(86) PCT No.: PCT/EP2017/060504

§ 371 Date: Oct. 19, 2018

(30) Foreign Application Priority Data
May 4, 2016 (EP) 16168280.2

(51) Int. Cl. C08L 15/00; C08C 19/20

(52) U.S. Cl. CPC C08L 15/00; C08C 19/20; C08L 2201/08; C08L 2205/06; C08L 2207/322; C08L 2205/03

(57) ABSTRACT

An elastomeric polymer of formula 1 is described,

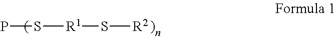

wherein S is a sulfur atom, P is a polymer chain that can be obtained by the anionic polymerization of at least one conjugated diene and optionally one or more vinyl aromatic compounds and that is optionally chain-end-modified, R¹ is selected independently from C₁-C₁₁ alkyl, C₆-C₁₁ aryl, C₇-C₁₁ aralkyl, and C₂-C₁₁ dialkyl ether, R² is selected independently from H, C₁-C₁₁ alkyl, C₆-C₁₁ aryl, C₇-C₁₁ aralkyl, C₂-C₁₁ dialkyl ether, and —SiR³R⁴R⁵, wherein R³, R⁴, and R⁵ are selected independently from H, C₁-C₁₆ alkyl, C₆-C₁₆aryl, and C₇-C₁₆ aralkyl, and wherein R³, R⁴, and R⁵ are selected independently from H, C⁶-C¹⁶ alkyl, C⁶-C¹⁶ aryl, and C⁷-C¹⁶ aralkyl, and n is an integer selected from 1-200, preferably 1 to 100, especially preferably 1 to 50, wherein the group(s) —S—R¹—S—R² is/are bonded to the backbone of the polymer chain P.

The present invention relates to novel elastomeric polymers, especially those substituted with one or more thioether groups at the polymer backbone. The invention also relates to a method for producing the polymers according to the invention, an unvulcanized polymer composition comprising at least the polymer of the invention and the use of the polymer composition for producing certain (vulcanized) rubber products.

### BACKGROUND

Cross-linking the polymer chains in an unvulcanized (uncross-linked) rubber blend (i.e. an unvulcanized (uncross-linked) elastomeric polymer composition) by means of a vulcanization system results in a three-dimensional, wide-mesh network so that, depending on the density of cross-linking, the cross-linked rubber becomes stiffer and less susceptible to tearing, especially tear propagation. The vulcanization process with sulfur results in sulfur bridges. The length of the sulfur bridges depends on the ratio of sulfur to accelerator, a distinction being made between conventional networks (sulfur/accelerator ratio of 10:1 to 2:1), semi-efficient networks (2:1 to 1:2) and efficient networks (1:2 to 1:10).

Conventional sulfur vulcanization produces cross-linked polymer chains with a plurality of free chain ends. When the rubber is deformed, the free polymer ends absorb energy and convert it to kinetic energy which leads to damping and deterioration of the roll resistance in pneumatic tire applications.

WO 2008/076875 A1 describes a composition consisting of a) an uncross-linked elastomeric polymer and b) a sulfidic modifier. Cross-linked rubber blends according to WO 2008/076875 A1 allegedly have a lower roll resistance in the presence of silicic acid fillers.

EP 1 101 789 A1 describes rubber blends containing at least one rubber produced by polymerizing diolefins and, optionally, vinylaromatic monomers and introduction of hydroxyl and/or carboxyl groups. The rubber has a total content of 0.05 to 5 wt. % of bound hydroxyl and/or carboxyl groups or relevant salts. The rubber blends also contain a compound capable of a cross-linking reaction with the hydroxyl- and/or carboxyl groups of the rubber. This compound is a sulfur-free cross-linker selected from polyisocyanates, polyuretdiones, blocked polyisocyanates or polyepoxides. The rubber blends are said to have high thermal and mechanical stress resistance, high wet grip, low roll resistance and high abrasion resistance and are therefore especially well-suited for tire applications.

US 2002/0045699 A1 describes a rubber obtainable from diolefins which has a content of 0.1 to 40 wt. % of non-polar, saturated linear side chains attached to the main chain via a sulfur atom. The rubber may comprise 0.1 to 2 wt. % of hydroxyl and/or carboxyl groups. Rubber blends or their vulcanizates containing the rubber allegedly have improved abrasion characteristics, reduced tear propagation and improved dynamic damping.

US 2006/0089445 A1 describes a method for preparing a grafted diene rubber with functional groups along the polymer chains. The method comprises a free-radical grafting reaction of a mercaptan with the diene rubber carried out in solution or without solvents. The grafting reaction is conducted in the presence of a radical starter. The method also comprises addition of an antioxidant before the grafting reaction. The mercaptan compound contains one of the following functional groups: hydroxyl, carbonyl, ether, amine, nitrile and silane. The method is said to result in a lower increase in viscosity during the grafting reaction and the rubbers obtained allegedly show less hysteresis loss in vulcanizates with silicic acid fillers.

US 2015/0299367 A1 describes a method for free-radical grafting to a diene elastomer comprising the following steps: a) dissolving at least one diene elastomer and at least one thiol in a solvent mixture consisting of at least one polar and at least one non-polar solvent, b) heating of the homogeneous mixture obtained to the temperature for the grafting reaction and c) addition of a radical starter. The method is said to produce higher yields for the grafting reaction as compared to the reaction in non-polar solvents.

Against the background described above, it is the object of the present invention to provide an elastomeric polymer having advantageous application characteristics, specifically when used for producing pneumatic tires for motor vehicles, especially with regard to roll resistance, wet grip and strength characteristics.

### SUMMARY

According to the invention, it was found that cross-linked (vulcanized) rubber compositions produced on the basis of a special modified elastomeric polymer result in reduced roll resistance in a pneumatic tire in a vehicle while other mechanical characteristics, especially wet grip and stability characteristics, remain substantially unchanged or even improve when compared to a cross-linked rubber composition on the basis of the unmodified elastomeric polymer. The advantageous characteristics are observed especially in those cases where a polymer composition comprising both the elastomeric polymer of the invention and one or more organic fillers was cross-linked (vulcanized). Moreover, it was found that the vulcanized rubber blends comprising the elastomeric polymer of the invention and soot or silicic acid for reinforcement have a reduced cross-linking density when compared with rubber blends comprising the unmodified elastomeric polymer.

In a first aspect, the invention provides an elastomeric polymer of the following formula 1:

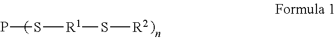

wherein
S is a sulfur atom,
P is a polymer chain which is obtainable by anionic polymerization of at least one conjugated diene and, optionally, one or more vinylaromatic compounds and which may, optionally, be modified at the chain end,
R¹ is independently selected from C₁-C₁₁ alkyl, C₆-C₁₁ aryl, C₇-C₁₁ aralkyl and C₂-C₁₁ dialkyl ether, preferably C₁-C₁₁ alkyl, especially preferably C₁-C₈ alkyl,
R² is independently selected from H, C₁-C₁₁ alkyl, C₆-C₁₁ aryl, C₇-C₁₁ aralkyl, C₂-C₁₁ dialkyl ether and —SiR³R⁴R⁵, wherein R³, R⁴ and R⁵ are independently selected from H, C₁-C₁₆ alkyl, C₆-C₁₆ aryl and C₇-C₁₆aralkyl, and R² is preferably selected independently from H and —SiR³R⁴R⁵, wherein R³, R⁴ and R⁵ are independently selected from H, C₁-C₁₆ alkyl, C₆-C₁₆ aryl and C₇-C₁₆ aralkyl, and
n is an integer selected from 1 to 200, preferably 1 to 100, especially preferably 1 to 50,
wherein the group(s) —S—R¹—S—R² is/are attached to the backbone of the polymer chain P.

In a second aspect, the invention provides a method for preparing the elastomeric polymer of formula 1 according to the first aspect of the invention, said method comprising the following steps.
(i) anionic polymerization of at least one conjugated diene and, optionally, one or more vinylaromatic compounds to obtain an anionic live polymer chain,
(ii) terminating polymerization, and
(iii) reacting the polymer chain with a compound of the following formula 2 in the presence of a radical starter:

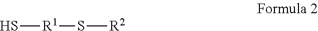

wherein
S is a sulfur atom,
R¹ is independently selected from C₁-C₁₁ alkyl, C₆-C₁₁ aryl, C₇-C₁₁ aralkyl and C₂-C₁₁ dialkyl ether, preferably C₁-C₁₁ alkyl, especially preferably C₁-C₈ alkyl, and
R² is independently selected from H, C₁-C₁₁ alkyl, C₆-C₁₁ aryl, C₇-C₁₁ aralkyl, C₂-C₁₁ dialkyl ether and —SiR³R⁴R⁵, wherein R³, R⁴ and R⁵ are independently selected from H, C₁-C₁₆ alkyl, C₆-C₁₆ aryl and C₇-C₁₆aralkyl, and R² is preferably selected independently from H and —SiR³R⁴R⁵, wherein R³, R⁴ and R⁵ are independently selected from H, C₁-C₁₆ alkyl, C₆-C₁₆ aryl and C₇-C₁₆ aralkyl.

In a third aspect, the invention provides an unvulcanized (uncross-linked) polymer composition comprising the elastomeric polymer according to the first aspect of the invention and one or more components selected from (i) components obtained as a result of the polymerization to produce the polymer chain P or added to the polymerization, and (ii) components remaining after the solvent has been removed from the polymerization.

In a fourth aspect, the invention provides the use of the unvulcanized polymer composition of the third aspect of the invention to produce (i) footwear, (ii) golf balls, (iii) membranes without reinforcements (such as fibers or tissue), (iv) adhesion promoters, (v) modified synthetic substances (such as polybutadiene/modified acrylonitrile/styrene copolymers (ABS) and high impact-resistance polystyrene (polybutadiene-modified polystyrene, HIPS) and (vi) films not intended for interior fittings in automobiles or aircrafts.

### DESCRIPTION

The elastomeric polymer of the first aspect of the present invention is generally represented by formula 1 as above.

The polymer chain P contained in the polymer of the invention is obtainable by anionic polymerization of at least one conjugated diene and, optionally, one or more vinylaromatic compounds, usually in the presence of an initiator. After polymerization has been terminated, the polymer chain P is reacted with a compound of the formula 2 in the presence of a radical starter. This causes modification of the backbone of the polymer chain by at least one group of the formula —S—R¹—S—R². According to the invention, a polymer chain is modified at the polymer backbone by up to 200 groups of the formula —S—R¹—S—R². Modification of the backbone of the polymer means modification of a recurring unit (monomer unit) of the polymer chain which is not a terminal recurring unit, said recurring unit being derived from a conjugated diene. For example, modification of the backbone of a polymer chain of the monomer units M₁ to M₁₀₀₀ corresponds to a modification at one or more of the monomer units M₂ to M₉₉₉. Within the meaning of the present invention, a modification at the monomer units M₁ and/or M₁₀₀₀ is not a modification of the backbone of the polymer chain, but a modification of the terminus of the polymer chain (chain end modification). A recurring unit may be modified with one group of the formula —S—R¹—S—R² maximum.

The chain ends of the polymer chain may optionally be modified by functional groups in full or in part. Chain end-modifying groups, the production thereof in a polymer during polymerization, for example by functional initiators, and/or the attachment thereof to the chain terminus of a polymer prepared by anionic polymerization are known to a person skilled in the art and are described, for example, in WO 2014/040640, WO 2014/040639, WO2015/010710, WO 2015/086039 and WO 2015/055252 and the European Patent Application no. 3133093A1, which are incorporated in this application by reference. Optional chain terminus modification of the polymer chain P may also be carried out by a group —S—R¹—S—R²; however, this group or these groups are not taken into account for determining the parameter value n in formula 1.

Exemplary conjugated dienes suitable for producing the polymer chain P include: 1,3-butadiene, 2-(C₁-C₅ alkyl)-1,3-butadiene, especially isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene and 1,3-cyclooctadiene. A mixture of two or more conjugated dienes may be used. Preferred conjugated dienes include: 1,3-butadiene and isoprene. In one embodiment, the conjugated diene is 1,3-butadiene.

The at least one conjugated diene for production of the polymer chain P is preferably used in a total amount of 30 to 100 wt. % based on the total amount of monomers.

The vinylaromatic compound optionally used for producing the polymer chain P comprises monovinylaromatic compounds, i.e. compounds having only one vinyl group attached to an aromatic group and the di-, tri etc. vinylaromatic compounds having two or more vinyl groups attached to an aromatic group. Exemplary vinylaromatic compounds that may optionally be used with the at least one diene to produce the polymer chain P comprise: styrene, C₁-C₄alkyl-substituted styrene, especially 2-methyl styrene, 3-methyl styrene, 4-methyl styrene, 2,4-dimethyl styrene, 2,4,6-trimethyl styrene, α-methyl styrene, 2,4-diisopropyl styrene and 4-tert-butyl styrene, stilbene, vinylbenzyl dimethyl amine, (4-vinylbenzyl)-dimethylaminoethyl ether, N,N-dimethylaminoethyl styrene, tert-butoxy styrene, vinylpyridine and divinylaromatic compounds, especially 1,2-divinyl benzene, 1,3-divinyl benzene and 1,4-divinyl benzene. A blend of two or more of these compounds may be used. A vinylaromatic compound preferably used is a monovinylaromatic compound, especially preferably styrene.

In general, the vinylaromatic compounds may be used in a total amount of up to 70 wt. %, especially 5 to 70 wt. %, preferably up to 60 wt. % and even more preferably up to 50 wt. % based on the total amount of monomers, provided the di-, tri- and higher vinylaromatic compounds are used in a total amount of not more than 1 wt. % based on the total amount of monomers. Even though there are no general limitations regarding the styrene portion used for producing the polymer chain, styrene typically is 5 to 70 wt. %, preferably 5 to 60 wt. %, and especially preferably 5 to 50 wt. % of the total amount of monomers. An amount of less than 5 wt. % of styrene may result in a deteriorated balance of roll resistance, wet grip and abrasion resistance as well as reduced mechanical strength while an amount of more than 70 wt. % may lead to higher hysteresis losses.

Other co-monomers than the conjugated diene and the vinylaromatic compound may be used in the preparation of the polymer chain P and comprise acryl monomers such as acrylonitrile, acrylate, e.g. acrylic acid, methyl acrylate, ethyl acrylate, propyl acrylate and butyl acrylate, and methacrylates, e.g. methyl methacrylate, ethyl methacrylate, propyl methacrylate and butyl methacrylate. The total amount of monomers other than the conjugated diene and the vinylaromatic compound preferably does not exceed 10 wt. %, especially preferably 5 wt. %, of all monomers. In a particularly preferred embodiment, no other co-monomers are used besides the conjugated diene and, optionally, the vinylaromatic compound.

In a particularly preferred embodiment, the polymer chain P may be obtained by random copolymerization of 1,3-butadiene as the conjugated diene with styrene as the vinylaromatic compound, styrene preferably being used in an amount of 5 to 70 wt. %.

The polymer chain P may be a random or block copolymer. The polymer chain P may also comprise polymer segments of different microstructures each of which has a random distribution of styrene.

Preferably 40 wt. % or more of the recurring styrene units are incorporated individually into the polymer chain, and 10 wt. % or less are “blocks” of eight or more styrene units incorporated one after the other. A polymer outside these limits may result in losses of hysteresis. The length of the vinylaromatic units incorporated one after the other including the recurring styrene units may be determined by an ozonolysis gel permeation chromatography method developed by Tanaka et al. (Polymer, Vol. 22, 1721-1723 (1981)).

Polymerization of the at least one conjugated diene and, optionally, one or more vinylaromatic compounds to obtain the polymer chain P is usually carried out in the presence of one or more initiators. Suitable initiators include organometallic compounds, especially organolithium compounds such as ethyl lithium, propyl lithium, n-butyl lithium, sec-butyl lithium, tert-butyl lithium, phenyl lithium, hexyl lithium, 1,4-dilithio-n-butane, 1,3-di(2-lithio-2-hexyl)benzene and 1,3-di(2-lithio-2-hexyl)benzene and 1,3-di(2-lithio-2-propyl)benzene. Among those, n-butyl lithium and sec-butyl lithium are preferred. The amount of the initiator is selected on the basis of the monomer quantity to be polymerized and the target molecular weight of the polymer chain P. The total amount of initiator is typically 0.05 to 20 mmol, preferably 0.1 to 10 mmol per 100 g of monomers (total amount of polymerizable monomers).

In addition, a polar coordinator compound may optionally be added to the monomer mixture or polymerization reaction to adjust the microstructure of the conjugated diene portion, i.e. the content of vinyl bonds or the composition distribution of a vinylaromatic compound that may be present in the polymer chain P. Two or more polar coordinator compounds may be used simultaneously. Polar coordinator compounds generally are Lewis bases and suitable Lewis bases comprise: ether compounds such as diethyl ether, di-n-butyl ether, ethylene glycol diethyl ether, ethylene glycol dibutyl ether, diethylene glycol dimethyl ether, propylene glycol dimethyl ether, propylene glycol diethyl ether, propylene glycol dibutyl ether, (C₁-C₈ alkyl) tetrahydrofuryl ether (incl. methyltetrahydrofuryl ether, ethyltetrahydrofuryl ether, propyltetrahydrofuryl ether, butyltetrahydrofuryl ether, hexyltetrahydrofuryl ether and octyltetrahydrofuryl ether), tetrahydrofuran, 2,2-(bistetrahydrofurfuryl) propane, bistetrahydrofurfuryl formal, methyl ether of the tetrahydrofurfuryl alcohol, ethyl ether of the tetrahydrofurfuryl alcohol, butyl ether of the tetrahydrofurfuryl alcohol, α-methoxytetrahydrofuran, dimethoxybenzene and dimethoxyethane, and tertiary amines such as triethyl amine, pyridine, N,N,N′,N′-tetramethylethylene diamine, dipiperidinoethane, methyl ether of the N,N-diethylethanol amine, ethyl ether of the N,N-diethylethanol amine, N,N-diethylethanol amine and dimethyl-N,N-tetrahydrofurfuryl amine. Examples of preferred polar coordinator compounds are described in WO 2009/148932 which is incorporated by reference.

The polar coordinator compound is typically added in a molar ratio of the polar coordinator compound to the initiator compound of 0.012:1 to 10:1, preferably 0.1:1 to 8:1 and especially preferably 0.25:1 to about 6:1.

The polymerization process used for producing the polymer chain is preferably conducted as a polymerization in solution in which the polymer formed is substantially soluble in the reaction mixture or as a suspension/three-phase (slurry) polymerization in which the polymer formed is substantially insoluble in the reaction mixture. Preferably, the polymer chain P is obtained through polymerization in solution. A hydrocarbon is conventionally used as the solvent which does not deactivate the initiator, the coordinator compound or the active polymer chain. Two or more solvents may be used in combination. Exemplary solvents include aliphatic and aromatic solvents. Specific examples (including all constitution isomers) are: propane, butane, pentane, hexane, heptane, octane, butene, propene, pentene, benzene, toluene, ethyl benzene and xylene. A polymerization in solution is usually conducted at a pressure of not more than 10 Mpa (absolute), preferably in a temperature range from 0 to 120° C. Polymerization may be conducted intermittently, continuously or semi-continuously.

In the elastomeric polymer of the formula 1, R¹ is independently selected from C₁-C₁₁ alkyl, C₆-C₁₁ aryl, C₇-C₁₁ aralkyl and C₂-C₁₁ dialkyl ether, preferably C₁-C₁₁ alkyl, especially preferably C₁-C₈ alkyl. Selected examples for R¹ are ethylidene [—(CH₂)₂—], propylidene [—(CH₂)₃—] and hexylidene [—(CH₂)₆—].

R² is independently selected from H, C₁-C₁₁ alkyl, C₆-C₁₁ aryl, C₇-C₁₁ aralkyl, C₂-C₁₁ dialkylether and —SiR³R⁴R⁵, wherein R³, R⁴ and R⁵ are independently selected from H, C₁-C₁₆ alkyl, C₆-C₁₆ aryl and C₇-C₁₆ aralkyl. R² is preferably selected independently from H and —SiR³R⁴R⁵, wherein R³, R⁴ and R⁵ are independently selected from H, C₁-C₁₆ alkyl, C₆-C₁₆ aryl and C₇-C₁₆ aralkyl. Selected examples for R² are —SiMe₃, —SiEt₃, —SiPr₃, —SiBu₃, —SiMe₂Et, —SiMe₂Pr, —SiMe₂Bu, —SiMe₂ (C₆H₁₃) and —SiMe₂ (C₈H₁₇), wherein Pr represents n-propyl or i-propyl and Bu represents n-butyl, t-butyl or i-butyl.

Selected examples for the partial structure —S—R¹—S—R₂ in formula 1 and formula 2 are —S—(CH₂)₂—S—SiMe₃, —S—(CH₂)₂—S—SiMe₂Et, —S—(CH₂)₂—S—SiMe₂Pr, —S—(CH₂)₂—S—SiMe₂Bu, —S—(CH₂)₂—S—SiEt₃, —S—(CH₂)₃—S—SiMe₃, —S—(CH₂)₃—S—SiMe₂Et, —S—(CH₂)₃—S—SiMe₂Pr, —S—(CH₂)₃—S—SiMe₂Bu, —S—(CH₂)₃—S—SiEt₃, —S—(CH2)₆—S—SiMe₃, —S—(CH₂)₆—S—SiMe₂Et, —S—(CH₂)₆—S—SiMe₂Pr, —S—(CH₂)₆—S—SiMe₂Bu and —S—(CH₂)₆—S—SiEt₃ where n is an integer selected from 1 to 200, preferably 1 to 100, especially preferably 1 to 50.

In general, the elastomeric polymer of formula 1 according to the first aspect of the invention is provided by a method comprising the following steps (second aspect of the invention):
(i) anionic polymerization of at least one conjugated diene and, optionally, one or more vinylaromatic compounds to obtain an anionic live polymer chain,
(ii) terminating polymerization, and
(iii) reacting the polymer chain with a compound of the following formula 2 in the presence of a radical starter:

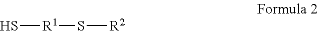

wherein, in general and preferred embodiments and combinations thereof, S, R¹ and R² are defined as for formula 1.

Step (i) of the process corresponds to the preparation of the polymer chain P described above; for details and conditions as well as preferred embodiments, reference is made to the preparation of the polymer chain P described above.

The anionic polymerization of step (i) and the anionic live polymer chain obtained as a result is terminated in a step (ii). This polymerization or chain termination may be carried out in a conventionally known manner by means of a proton source or a functional reagent. One means for chain termination contains at least one active hydrogen atom capable of reacting with the anionic polymer chain end and protonating the latter. One or two or more chain termination means may be used in combination. Suitable chain termination means include water (steam), alcohols, amines, mercaptans and organic acids, preferably alcohols and especially preferably C₁-C₄ alcohols, preferably methanol and ethanol and especially preferably methanol. One or more compounds modifying the chain terminus may be used instead of or together with the chain termination means to modify the polymer chain at its termini. Compounds of this kind are known to the person skilled in the art from the prior art; by way of example, we refer to the disclosure of the documents WO 2014/040640, WO 2014/040639, WO 2015/086039 and WO 2015/055252 already cited above.

After terminating the chain in step (ii), the polymer obtained which has been deactivated at the chain termini is reacted with a compound of the formula 2 in the presence of a radical starter. The reaction results in modification of the backbone of the polymer chain and thus in an elastomeric polymer of formula 1. The modification in step (iii) is typically carried out directly after step (ii). Optionally, however, the solvent may be removed and/or exchanged after step (ii) before modification is carried out in step (iii).

The amount of the compound(s) of formula 2 added in step (iii) depends on the length of the polymer chain P and the desired index n in formula 1. Typically, this amount is 0.01 to 10 wt. % based on the total amount of all monomers, preferably 0.025 to 7.5 wt. % and especially preferably 0.05 to 5 wt. %.

The radical starter is typically added in an amount of 1-25 mol %, preferably 2-20 mol %, based on the amount of the compound(s) of formula 2 used. The reaction in step (iii) is generally carried out at a temperature of 50 to 180° C., preferably 60 to 150° C.

The radical starter used in step (iii) may, for example, be selected from peroxides, azo initiators and photo initiators, and two or more radical starters may be used in combination. Preferably, a peroxide is used as the radical starter, such as lauroyl peroxide, dicumyl peroxide, benzoyl peroxide, tert-butyl peroxide or 1,1-di(tert.-butylperoxy)-3,3,5-trimethyl cyclohexane. One example for an azo initiator is 2,2′-azobis(2-methylpropionitrile).

The unvulcanized polymer composition according to the third aspect of the invention comprises the elastomeric polymer according to the first aspect of the invention and one or more components selected from (i) components obtained as a result of the polymerization to produce the polymer chain P or added to the polymerization, and (ii) components remaining after the solvent has been removed from the polymerization.

The unvulcanized (uncross-linked) polymer composition is typically obtained by working up the reaction mixture obtained in step (iii). Working up means removing the solvent by distillation or vacuum evaporation.

Components obtained as a result of the polymerization to obtain the polymer chain P or added to the polymerization especially comprise stretching oils, stabilizers, fillers and other polymers. The elastomeric polymer of formula 1 according to the invention is preferably contained in the polymer composition in an amount of at least 15 wt. %, preferably at least 30 wt. % and even more preferably at least 45 wt. % based on the total quantity of polymer in the composition. The remaining amount of polymer not according to the invention is composed of the other polymers not according to the invention which are created or added during polymerization.

One or more oils may be added to the elastomeric polymer before or after step (iii), preferably after step (iii). Examples and a classification of oils are cited in WO 2009/148932 and US 2005/0159513 both of which are incorporated by reference. The polymer composition may contain oils in a total amount of 0 to 70 phr, preferably 0.1 to 60 phr and especially preferably 0.1 to 50 phr.

Optionally, one or more stabilizers (“antioxidants”) may be added to the elastomeric polymer before or after step (iii), preferably after step (iii), to prevent degradation of the elastomeric polymer by molecular oxygen. Antioxidants based on sterically hindered phenols such as 2,6-di-tert-butyl-4-methyl phenol, 6,6′-methylene-bis(2-tert-butyl-4-methyl phenol), isooctyl-3-(3,5-di-tert-butyl-4-hydroxyphenyl) propionate, hexamethylene bis[3-(3,5-di-tert-butyl-4-hydroxyphenyl)propionate], octadecyl-3-(3,5-di-tert-butyl-4-hydroxyphenyl) propionate, isotridecyl-3-(3,5-di-tert-butyl-4-hydroxyphenyl) propionate, 1,3,5-trimethyl-2,4,6-tris(3,5-di-tert-butyl-4-hydroxybenzyl) benzene, 2,2′-ethylidene-bis-(4,6-di-tert-butylphenol), tetrakis[methylene-3-(3,5-di-tert-butyl-4-hydroxyphenyl)propionate] methane, 2-[1-(2-hydroxy-3,5-di-tert-pentylphenyl)ethyl]-4,6-di-tert-pentylphenyl acrylate and 2-tert-butyl-6-(3-tert-butyl-2-hydroxy-5-methylbenzyl)-4-methylphenyl acrylate, and antioxidants based on thioesters such as 4,6-bis(octylthiomethyl)-o-cresol and pentaerythrityl-tetrakis(3-laurylthiopropionate) are typically used. Further examples of suitable stabilizers are described in Röthemeyer-Sommer, Kautschuk Technologie, 2^{nd} ed. (Hanser Verlag, 2006) 340-344, with additional references.

One or more fillers may be added to the polymer during the anionic polymerization (i), after the anionic polymerization (i) and before termination of the polymerization (ii), after termination of the polymerization (ii) and before reacting (iii) the polymer with the compound of formula 2 and/or after reacting (iii) the polymer with the compound of formula 2, preferably after reacting (iii) the polymer with the compound of formula 2.

Example of suitable fillers include: soot (including conductive soot), carbon nano tubes (CNT) (including discrete CNTs, hollow carbon fibers (HCF) and modified CNTs bearing one or more functional groups such as hydroxyl, carboxyl and carbonyl), graphite, graphene (including discrete graphene platelets), silicic acid, a two phase filler of carbon and silicic acid, clays (layered silicates including expanded clays and organic clays), calcium carbonate, magnesium carbonate, lignin, amorphous fillers such as fillers on glass particle basis, fillers on starch basis and combinations thereof. Further examples of suitable fillers are described in WO 2009/148932 which is incorporated by reference. Fillers may be used in the polymer composition in amounts familiar to a person skilled in the art. For example, soot may typically be used in an amount of 2 to 100 parts by weight or 5 to 100 parts by weight or 10 to 100 parts by weight or 10 to 95 parts by weight per 100 parts by weight of the total polymer content.

Additional polymers as part of the polymer composition of the invention are polymers which are formed during the polymerization process, but are not elastomeric polymers according to formula 1 of the invention.

The elastomeric polymer of formula 1 according to the first aspect of the invention and the relevant unvulcanized polymer composition of the third aspect of the invention may advantageously be used to produce (i) footwear, (ii) golf balls, (iii) membranes without reinforcements, (iv) adhesion promoters, (v) modified synthetic substances and (vi) films not intended for interior fittings in automobiles or aircrafts. The reinforcements mentioned under (iii) are fibers and tissue, for example. The modified synthetic substances mentioned under (v) are, for example, polybutadiene/modified acrylonitrile/styrene copolymers (ABS) and high-impact resistant polystyrene (HIPS).

### EXAMPLES

“Room temperature” (RT) as used here means a temperature of about 20 to 25° C. or, when a specific parameter is measured, 20° C.

### Synthesis of the Polymer Backbone Modifier BM1

1,6-hexanedithiol (12.7 g, 84.2 mmol) was dissolved in 300 mL of tert-butylmethyl ether and n-BuLi (30.0 g mL, 92.5 mmol, 20 wt. % in cyclohexane) added dropwise. The mixture was stirred at room temperature for 2 hrs, and tert-butyldimethyl chlorosilane was added (12.6 g, 83.7 mmol). After refluxing the mixture over night, water was added. The organic phase was separated and washed twice with water. The aqueous phases collected were combined and washed with diethyl ether. The collected and combined organic phases were dried with sodium sulfate and the volatile components removed in vacuo. The residue was subjected to fractional distillation, yielding 64% of BM1, boiling point 105° C. at 0.2 mbar.

¹H-NMR (400 Hz, C₆D₆, 298 K): δ=0.21 (s, 6H, Si(CH₃)₂); 0.99 (s, 9H, C(CH₃)₃); 1.15-1.05 (m, 3H, CH₂/SH); 1.23-1.15 (m, 2H, CH₂); 1.29 (qu, 2H, CH₂); 1.50 (qu, 2H, CH₂); 2.12 (q, 2H, CH₂—SH); 2.40 (t, 2H, CH₂—S—Si); ¹³C-NMR (101 Hz, C₆D₆, 298 K): δ=−3.09 (CH₃), 19.50 (CH₂), 24.90 (CH₂), 26.91 (CH₃), 27.04 (CH₂), 28.43 (CH₂), 28.67 (CH₂), 33.63 (CH₂), 34.53 (CH₂).

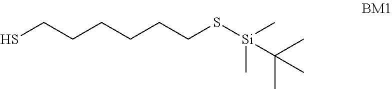

Co-Polymerization of 1,3-Butadiene with Styrene (Comparative Polymer V)

Co-polymerization was carried out in a jacketed 40 I steel reactor which had been rinsed with nitrogen before addition of the organic solvent, the monomers, the polar coordinator compound, the initiator compound and other components. The following components were added in the order indicated: cyclohexane solvent (18,560 g); butadiene monomer (1,777 g), styrene monomer (448 g) and tetramethylethylene diamine (TMEDA, 1.0 g), and the mixture was heated to 40° C., followed by titration with n-butyl lithium to remove traces of humidity or other impurities; n-BuLi (17.6 mmol) was added to the polymerization reactor to start the polymerization reaction. Polymerization was carried out for 20 minutes while the polymerization temperature was kept at not more than 70° C. Then butadiene (1,202 g) and styrene (91 g) were added as the monomers over 55 minutes. Polymerization was conducted for a further 20 minutes, followed by the addition of 63 g of butadiene monomer. After 20 minutes, polymerization was terminated by adding methanol (one equivalent on the basis of the initiator). 0.25 wt. % of IRGANOX 1520 based on the total monomer weight was added to the polymer solution as a stabilizer. This mixture was stirred for 10 minutes. The resulting polymer solution was then stripped with steam for one hour to remove solvent and other volatile substances and dried in an oven at 70° C. for 30 minutes plus an additional three days at room temperature.

### Preparation of the Backbone-Modified Polymer A

First, co-polymerization of 1,3-butadiene and styrene was carried out analogously to the preparation of the comparative polymer V. Backbone modification was conducted in a jacketed 10 I steel reactor which was first rinsed with nitrogen before the comparative polymer V (4,000 g) was added, followed by the addition of cyclohexane (2,000 g) and the backbone modifier BM1 (7.7 g, 29.1 mmol). The mixture was heated to 95° C., and a lauroyl peroxide solution in cyclohexane was added in four portions every 30 minutes (1.13/0.86/0.57/0.28 mmol, 2.84 mmol altogether). The polymer solution was cooled to room temperature and 1.2 g of IRGANOX 1520 added. A GC analysis of unreacted backbone modifier BM1 showed a graft yield of 60%. The modified polymer solution was then stripped with steam for one hour to remove solvent and other volatile substances and dried in an oven at 70° C. for 30 minutes plus an additional three days at room temperature.

### Preparation of Polymer A′ by Extraction of the Unreacted Backbone Modifier BM1 From Polymer 1

Polymer A (94 g) was comminuted in a cutting mill and the rubber crumbs obtained suspended in isopropanol (800 g). The suspension was refluxed for 8 hours and the rubber crumbs separated and dried. GC analysis showed that 90% of the backbone modifier BM1 obtained had been removed.

TABLE 1
Analytical data on the comparative polymer V and polymer A

| | | | | Vinyl | Styrene | |
|---|---|---|---|---|---|---|
| | Mw | Mn | Mooney | content | content | Tg |
| | [g/mol] | [g/mol] | viscosity | [wt. %] | [wt. %] | [° C.] |
| Comparative | 334417 | 303967 | 35.3 | 29.2 | 15.1 | −60.6 |
| polymer V | | | | | | |
| Polymer A | 476469 | 358682 | 66.2 | 29.6 | 14.7 | −60.7 |

### Preparation of Rubber Mixtures and Comparative Experiments

The invention will now be explained in greater detail with the aid of comparative examples and exemplary embodiments summarized in Tables 4 to 6. The blends designated “E” are blends according to the invention while the blends designated “V” are comparative blends.

The quantities given in all of the exemplary mixtures contained in the Table are parts by weight based on 100 parts by weight of total rubber (phr) or 100 parts by weight of silicic acid (phf).

The mixtures were prepared under the usual conditions in two stages in a tangential lab blender.

The rubber blends E1, E2 and E4 contain 90 phr of polymer A according to the invention (formula 1). In the rubber blends V1, V3 and V4, the comparative polymer V which is comparable to polymer A in molecular weight, vinyl content and styrene content was used instead of the polymer A according to formula 1. The comparative polymer is not modified and is not a coupled polymer.

The rubber blend V2 was adjusted to the same hardness at 70° C. with a larger amount of vulcanization reagents (accelerators and sulfur) as E1 and thus is a reference product with the same hardness.

The rubber blend E3 according to the invention contains the polymer A′ which was obtained after modification of polymer A by purification, i.e. separation of any modifier BM1 that may still have remained.

Test specimens were prepared from all blends by vulcanization and material characteristics typical for the rubber industry determined with these specimens. The following test methods were used for the tests on specimens described above:
Shore A hardness (unit Shore A, abbreviated ShA) at room temperature (RT) and 70° C. according to DIN 53 505
Impact resilience (in short: resilience) at room temperature (RT) and 70° C. according to DIN 53 512
Tensile moduli at 50%, 100%, 200%, 300% elongation (module 50, module 100, module 200 and module 300) at room temperature (RT) according to DIN 53 504
Tensile strength and elongation at break at room temperature according to DIN 53 504
Abrasion at room temperature according DIN53 516 and DIN/ISO 4649
Maximum loss factor tan δ (max) from a dynamical/mechanical measurement according to DIN 53 513 (temperature sweep)

TABLE 4

| | Unit | V1 | V2 | E1 |
|---|---|---|---|---|
| Component | | | | |
| NR TSR | phr | 10 | 10 | 10 |
| Comparative polymer V | phr | 90 | 90 | — |
| Polymer A | phr | — | — | 90 |
| Soot N339 | phr | 85 | 85 | 85 |
| Oil TDAE | phr | 45 | 45 | 45 |
| Antioxidant ^{a)} | phr | 4 | 4 | 4 |
| Stearic acid | phr | 2.5 | 2.5 | 2.5 |
| Zinc oxide | phr | 2.5 | 2.5 | 2.5 |
| Accelerator CBS | phr | 6.4 | 9.6 | 6.4 |
| Sulfur | phr | 0.64 | 0.96 | 0.64 |
| Physical properties | | | | |
| Shore hardness at RT | Shore A | 65 | 68 | 66 |
| Shore hardness at 70° C. | Shore A | 60.4 | 64 | 64 |
| Resilience at RT | % | 31 | 31.8 | 37.8 |
| Resilience at 70° C. | % | 45.8 | 49.1 | 55.3 |
| Diff. Resilience (70° C. − RT) | | 14.8 | 17.3 | 17.5 |
| Module 50 | MPa | 1.4 | 1.7 | 1.8 |
| Module 100 | MPa | 2.5 | 3.5 | 4.2 |
| Tensile strength | MPa | 11.7 | 11.7 | 11.3 |
| Elongation at break | % | 342 | 265 | 206 |
| Tan δ (max) | | 0.259 | 0.243 | 0.188 |
| Abrasion | mm³ | 94 | 129 | 92 |

TABLE 5

| | Unit | V3 | E2 | E3 | V4 | E4 |
|---|---|---|---|---|---|---|
| Component | | | | | | |
| NR TSR | phr | 10 | 10 | 10 | 10 | 10 |
| Comparative polymer V | phr | 90 | — | — | 90 | — |
| Polymer A | phr | — | 90 | — | — | 90 |
| Polymer A′ | phr | — | — | 90 | — | — |
| Silicic acid ^{b)} | phr | 95 | 95 | 95 | 95 | 95 |
| Silane ^{c)} | phf | 7.2 | 7.2 | 7.2 | — | — |
| Silane ^{d)} | phf | — | — | — | 8.1 | 8.1 |
| Oil TDAE | phr | 35 | 35 | 35 | 35 | 35 |
| Antioxidant ^{a)} | phr | 4 | 4 | 4 | 4 | 4 |
| Stearic acid | phr | 2.5 | 2.5 | 2.5 | 2.5 | 2.5 |
| Zinc oxide | phr | 2.5 | 2.5 | 2.5 | 2.5 | 2.5 |
| DPG | phr | 2.0 | 2.0 | 2.0 | 2.0 | 2.0 |
| CBS | phr | 6.4 | 6.4 | 6.4 | 6.4 | 6.4 |
| Sulfur | phr | 0.64 | 0.64 | 0.64 | 0.64 | 0.64 |
| Physical properties | | | | | | |
| Hardness at RT | Shore A | 74.2 | 73.9 | 76 | 74.2 | 73.9 |
| Hardness at 70° C. | Shore A | 69.6 | 70.6 | 72.2 | 69.6 | 70.6 |
| Resilience RT | % | 36.9 | 41 | 40.5 | 36.9 | 41 |
| Resilience 70° C. | % | 47.4 | 55.9 | 54.6 | 47.4 | 55.9 |
| Diff. Resilience | | 10.5 | 14.9 | 14.1 | 10.5 | 14.9 |
| Module 50 | MPa | 1.8 | 2.1 | 2.1 | 1.8 | 2.1 |
| Module 100 | MPa | 2.9 | 4.2 | 4 | 2.9 | 4.2 |
| Module 200 | MPa | 5.6 | 10 | 10.1 | 5.6 | 10 |
| Tensile strength | MPa | 16.4 | 15 | 18 | 16.4 | 15 |
| Elongation at break | % | 506 | 296 | 329 | 506 | 296 |
| Tan δ (max) | | 0.212 | 0.167 | 0.174 | 0.212 | 0.167 |
| Abrasion | mm³ | 61 | 77 | 58 | 61 | 77 |

TABLE 6

| Component | Unit | V5 | V6 | V7 | V8 | V9 | V10 |
|---|---|---|---|---|---|---|---|
| NR TSR | phr | 10 | 10 | 10 | 10 | 10 | 10 |
| Comparative | phr | 90 | 90 | 90 | 90 | 90 | 90 |
| polymer V | | | | | | | |
| Modifier ^{e)} | phr | — | 0.85 | 3.0 | — | 3.0 | — |
| Modifier ^{f)} | phr | — | — | — | — | — | 7.75 |
| Soot N339 | phr | — | — | — | 85 | 85 | 85 |
| Silicic acid ^{b)} | phr | 95 | 95 | 95 | — | — | — |
| Silane ^{c)} | phf | 7.2 | 7.2 | 7.2 | — | — | — |
| Oil TDAE | phr | 35 | 35 | 35 | 45 | 45 | 45 |
| Antioxidant ^{a)} | phr | 4 | 4 | 4 | 4 | 4 | 4 |
| Stearic acid | phr | 2.5 | 2.5 | 2.5 | 2.5 | 2.5 | 2.5 |
| Zinc oxide | phr | 2.5 | 2.5 | 2.5 | 2.5 | 2.5 | 2.5 |
| DPG | phr | 2.0 | 2.0 | 2.0 | — | — | — |
| CBS | phr | 6.4 | 6.4 | 6.4 | 6.4 | 6.4 | 6.4 |
| Sulfur | phr | 0.64 | 0.64 | 0.64 | 0.64 | 0.64 | 0.64 |

Physical properties

| | | | | | | | |
|---|---|---|---|---|---|---|---|
| Hardness at RT | Shore A | 74.1 | 75.8 | 73.4 | 64 | 60 | 56 |
| Hardness at 70° C. | Shore A | 69.6 | 71.0 | 68.2 | 59 | 55 | 49 |
| Resilience RT | % | 18.0 | 17.8 | 18.5 | 18 | 19 | 20 |
| Resilience 70° C. | % | 46.5 | 48.0 | 47.6 | 37 | 40 | 35 |
| Diff. Resilience | | 28.5 | 30.2 | 29.1 | 19 | 21 | 15 |
| Module 50 | MPa | 2.0 | 2.2 | 1.8 | — | — | — |
| Module 100 | MPa | 3.7 | 3.9 | 3.1 | 2.09 | 1.90 | 1.24 |
| Module 200 | MPa | 7.3 | 7.7 | 6.1 | 5.63 | 5.17 | 2.79 |
| Tensile strength | MPa | 12 | 11 | 12 | 14.4 | 14.3 | 12.9 |
| Elongation at break | % | 318 | 288 | 368 | 412 | 459 | 627 |
| Tan δ (max) | | 0.196 | 0.195 | 0.206 | 0.272 | 0.268 | 0.299 |
| Abrasion | mm³ | 175 | 135 | 146 | 181 | 211 | 312 |

Substances used:
^{a)} Antioxidant: Ozone protection wax and 6PPD
^{b)} Silicic acid VN3, Evonik
^{c)} Silane: S2-Silane, 75 wt. % disulfides, e.g. Si 266 ®, Evonik Industries AG
^{d)} Blocked mercaptosilane NXT, 3-(octanoylthio)-1-propyltriethoxy silane, Momentive
^{e)} Modifier: 1,6-hexane dithiol
^{f)} Modifier: double-protected 1,6-hexane dithiol:

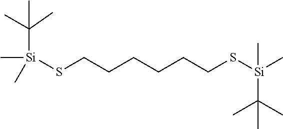 [SMILES: CC(C)(C)[Si](C)(C)SCCCCCCS[Si](C)(C)C(C)(C)C]

As Table 4 shows, the rubber blend E1 according to the invention which contains soot as a filler as compared to the comparative blend V1 shows an improvement in the target conflict of roll resistance and wet grip which is evident from the greater difference of the two indicators impact resilience at 70° C. (roll resistance) and room temperature (wet grip). Moreover, the improved roll resistance of E1 is evident from the lower value for the maximum loss factor (tan δ max). In addition, the rubber blend according to the invention E1 shows an abrasion behavior and tensile strength which are comparable to V1.

When compared to the reference product V2 of the same hardness, the rubber blend E1 according to the invention shows improved abrasion behavior.

As Table 5 shows, the rubber blends E2, E3 and E4 according to the invention which contain silicic acid as a filler as compared to the comparative blends V3 and V4 show an improvement in the target conflict of roll resistance and wet grip which is evident from the greater differences of the two indicators impact resilience at 70° C. (roll resistance) and room temperature (wet grip). It seems that the purification of the polymer after modification (E3 with a purified modified polymer A′ vs. E2 with a modified polymer A) has no significant influence on the improvement of the target conflict of roll resistance and wet grip. When compared to the respective comparative blends, the abrasion behavior of E2 and E4 is at an acceptable level, while E2 which contains the purified polymer A′ surprisingly shows good abrasion behavior.

Therefore, it is possible with the rubber blend according to the invention, especially when it is used in the tread, to further improve the target conflict of roll resistance and wet grip on the basis of the prior art without any deterioration of the abrasion resistance.

As can be inferred from Table 6, improvements are not observed either with 1,6-hexane dithiol (V6 or V7 versus V5 and V9 versus V8) or with the double-protected 1,6-hexane dithiol (V10 versus V8) which are added to the comparative polymer V as modifiers during mixing of the rubber blend without being linked to the polymer first. Here, either the differences of the resilience and the tan δ deteriorate or remain at the same level while the abrasion resistance deteriorates.

In other words, it is essential to the invention that the polymer is already modified according to formula I) before being mixed into the rubber blend together with the other components of the blend rather than adding the unmodified polymer and the modifier separately to the rubber blend.

While the concepts of the present disclosure are susceptible to various modifications and alternative forms, specific exemplary embodiments of the disclosure have been shown by way of examples. It should be understood, however, that there is no intent to limit the concepts of the present disclosure to the particular disclosed forms; the intention is to cover all modifications, equivalents, and alternatives falling within the spirit and scope of the invention as defined by the claims.

1. An elastomeric polymer of the following formula 1: 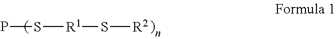
wherein
S is a sulfur atom,
P is a polymer chain which is obtainable by anionic polymerization of at least one conjugated diene and, optionally, one or more vinylaromatic compounds and which may, optionally, be modified at the chain end,
R¹ is independently selected from C₁-C₁₁ alkyl, C₆-C₁₁ aryl, C₇-C₁₁ aralkyl and C₂-C₁₁ dialkyl ether,
R² is independently selected from H, C₁-C₁₁ alkyl, C₆-C₁₁ aryl, C₇-C₁₁ aralkyl, C₂-C₁₁ dialkyl ether and —SiR³R⁴R⁵, wherein R³, R⁴ and R⁵ are independently selected from H, C₁-C₁₆ alkyl, C₆-C₁₆ aryl and C₇-C₁₆aralkyl, wherein R³, R⁴ and R⁵ are independently selected from H, C₁-C₁₆ alkyl, C₆-C₁₆ aryl and C₇-C₁₆ aralkyl, and
n is an integer selected from 1 to 200,
wherein the group(s) —S—R¹—S—R² is/are attached to the backbone of the polymer chain P.

2. An elastomeric polymer according to claim 1, wherein the at least one conjugated diene is selected from 1,3-butadiene, 2-(C₁-C₅ alkyl)-1,3-butadiene, especially isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene and 1,3-cyclooctadiene.

3. An elastomeric polymer according to claim 2, wherein the conjugated diene is 1,3-butadiene.

4. The elastomeric polymer according to claim 1, wherein the at least one conjugated diene is used in a total amount of 30 to 100 wt. % based on the total amount of monomers.

5. The elastomeric polymer according to claim 1, wherein the vinylaromatic compound is selected from styrene, C₁-C₄alkyl-substituted styrene, especially 2-methyl styrene, 3-methyl styrene, 4-methyl styrene, 2,4-dimethyl styrene, 2,4,6-trimethyl styrene, α-methyl styrene, 2,4-diisopropyl styrene and 4-tert-butyl styrene, stilbene, vinylbenzyl dimethyl amine, (4-vinylbenzyl)-dimethylaminoethyl ether, N,N-dimethylaminoethyl styrene, tert-butoxystyrene, vinyl pyridine and divinylaromatic compounds.

6. The elastomeric polymer according to claim 5, wherein the vinylaromatic compound is styrene.

7. The elastomeric polymer according to claim 1, wherein the one or more vinylaromatic compounds may be used in a total amount of up to 5 to 70 wt. % based on the total amount of monomers, provided the di-, tri- and higher vinylaromatic compounds are used in a total amount of not more than 1 wt. % based on the total amount of monomers.

8. A method for preparing the elastomeric polymer of formula 1 as defined in claim 1 comprising the following steps:
(i) anionic polymerization of at least one conjugated diene and, optionally, one or more vinylaromatic compounds to obtain an anionic live polymer chain,
(ii) terminating polymerization, and
(iii) reacting the polymer chain with a compound of the following formula 2 in the presence of a radical starter: 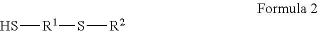
wherein
S is a sulfur atom,
R¹ is independently selected from C₁-C₁₁ alkyl, C₆-C₁₁ aryl, C₇-C₁₁ aralkyl and C₂-C₁₁ dialkyl ether, and
R² is independently selected from H, C₁-C₁₁ alkyl, C₆-C₁₁ aryl, C₇-C₁₁ aralkyl, C₂-C₁₁ dialkyl ether and —SiR³R⁴R⁵, wherein R³, R⁴ and R⁵ are independently selected from H, C₁-C₁₆ alkyl, C₆-C₁₆ aryl and C₇-C₁₆ aralkyl, wherein R³, R⁴ and R⁵ are independently selected from H, C₁-C₁₆ alkyl, C₆-C₁₆ aryl and C₇-C₁₆ aralkyl.

9. A method according to claim 8, wherein termination of the polymerization in step (ii) comprises reacting the anionic live polymer chain with a proton source or a functional reagent.

10. A method according to claim 8, wherein the radical starter is selected from peroxides, azo initiators and photo initiators, especially peroxides.

11. An unvulcanized polymer composition comprising the elastomeric polymer according to claim 1 and one or more components selected from (i) components obtained as a result of the polymerization to produce the polymer chain P or added to the polymerization, and (ii) components remaining after the solvent has been removed from the polymerization.

12. The unvulcanized polymer composition according to claim 11 comprising one or more components selected from stretching oils, stabilizers, fillers and additional polymers.

13. The elastomeric polymer according to claim 11 being formed into (i) footwear, (ii) golf balls, (iii) membranes without reinforcements, (iv) adhesion promoters, (v) modified synthetic substances and (vi) films not intended for interior fittings in automobiles or aircrafts.
